(19) United States
(12) Patent Application Publication
(10) Pub. No.: US 2020/0059730 A1
(43) Pub. Date: Feb. 20, 2020

(54) SPEAKER

(71) Applicant: AAC Technologies Pte. Ltd., Singapore City (SG)

(72) Inventor: Xiaojiang Gu, Shenzhen (CN)

(21) Appl. No.: 16/529,798

(22) Filed: Aug. 2, 2019

(30) Foreign Application Priority Data
Aug. 17, 2018 (CN) 201821343429.0

(51) Int. Cl. H04R 9/06; H04R 7/18; H04R 1/28; H04R 9/02

(52) U.S. Cl. CPC H04R 9/06; H04R 7/18; H04R 2499/11; H04R 9/025; H04R 2400/11; H04R 1/288

(57) ABSTRACT

The present application discloses a speaker. The speaker includes a frame, a vibration system accommodated in the frame, a magnetic circuit system accommodated in the frame, an upper cover covered upon the frame, wherein the upper cover comprises a cover body and a metal sheet embedded into the cover body; the metal sheet comprises a base portion located at a center thereof and a bending portion extending from a periphery of the base portion toward the frame; the bending portion comprises a first segment and a second segment connected between the first segment and the base portion; an orthographic projection of the first segment projected toward the base portion falls within a range of the base portion.

### FIELD OF THE PRESENT DISCLOSURE

The present disclosure relates to an electro-acoustic device, and more particularly to a speaker.

### DESCRIPTION OF RELATED ART

In a rapid development of portable devices such as mobile phones, people are becoming more and more demanding on functionality of the products, especially demanding on the sound-producing performance of the products. Therefore, the development of a speaker equipped in them is becoming more faster.

A related speaker includes a frame, a vibration unit and a magnetic circuit unit both accommodated in the frame, and an upper cover covered upon the frame. The upper cover includes a cover body and a metal sheet embedded into the cover body. The metal sheet includes a base portion located at a center thereof and a bending portion extending from an edge of the base portion toward the frame. The bending portion extends in a direction away from each other. In such speaker, the metal sheet is connected with the cover body by means of the bending portion embedding into the cover body, and the bending portion extends in the direction away from each other. With such configuration, after the metal sheet injected into the cover body, since a bonding force between the metal sheet and the cover body is small, the upper cover of the speaker is easily detached, so that the reliability of the speaker is degraded.

Therefore, it is desirable to provide a new speaker which can overcome the above-mentioned problems.

### BRIEF DESCRIPTION OF THE DRAWINGS

FIG. 1 is an isometric view of a speaker in accordance with an embodiment of the present invention.

FIG. 2 is an isometric and exploded view of the speaker in FIG. 1.

FIG. 3 is a cross-sectional view of the speaker taken along line A-A of FIG. 1.

FIG. 4 is an enlarged view of circled part B in FIG. 3.

### DETAILED DESCRIPTION OF THE EXEMPLARY EMBODIMENT

The present disclosure will hereinafter be described in detail with reference to exemplary embodiment and drawings.

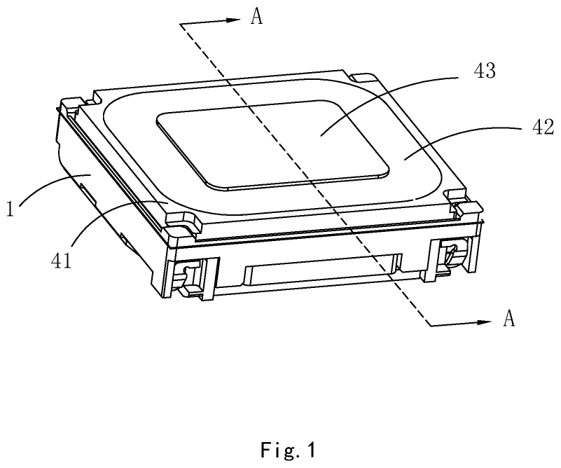

Referring to FIGS. 1-3, a speaker 100 according to the present invention comprises a frame 1, a vibration system 2 and a magnetic circuit system 3 accommodated in the frame 1, an upper cover 4 covered upon the frame 1, and a conductive terminal 6 connected with the frame 1.

Referring to FIGS. 1-4, the upper cover 4 comprises a cover body 41, a metal sheet 42 embedded into the cover body 41 and a first damping net 43 attached on the metal sheet 42. The metal sheet 42 comprises a base portion 421 located at a center thereof and a bending portion 422 extending from a periphery edge of the base portion 421 in a direction toward the frame 1. The bending portion 422 comprises a first segment 422a, a second segment 422b connected between the first segment 422a and the base portion 421. An orthographic projection of the first segment 422a projected toward the base portion 421 falls into the range of the base portion 421. Preferably, the first segment 422a is parallel to the base portion 421. Additionally, a through hole 41a is defined in the center of the cover body 41, and the metal sheet 42 covered upon the through hole 41a. The metal sheet 42 has an opening 42a and the first damping net 43 covers upon the opening 42a.

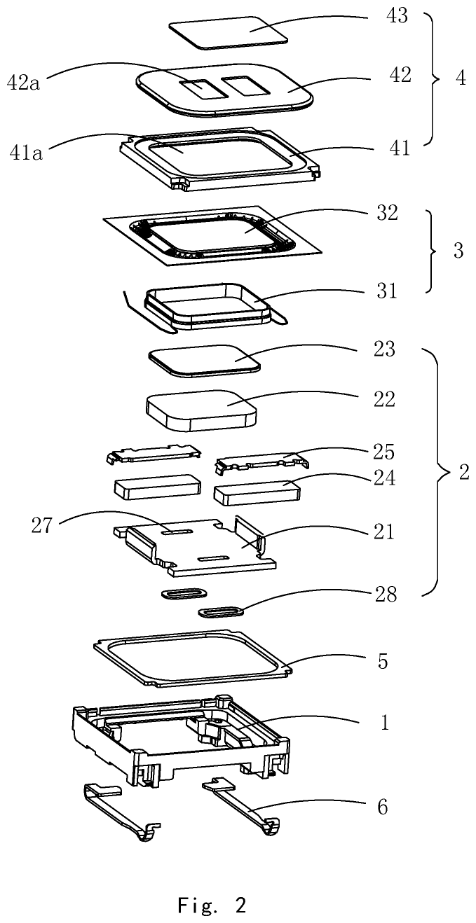

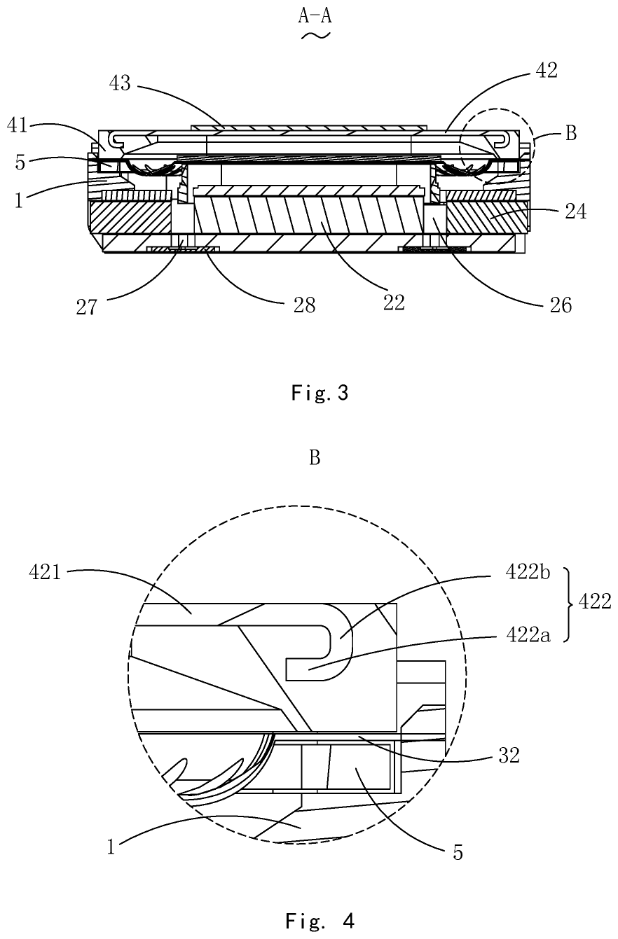

Referring to FIG. 2 and FIG. 3, the magnetic circuit system 2 comprises a yoke 21, a main magnet 22 attached on the yoke 21, a magnet conductive plate 23 attached upon the main magnet 22, an auxiliary magnet 24 disposed at both sides of the main magnet 22 and an upper plate 25 attached on the auxiliary magnet 24. A magnet gap is formed between the main magnet 22 and the auxiliary magnet 24. A leaking hole 27 is defined in the yoke 21 and located at a position corresponding to the magnet gap 26. A second damping net 28 covers upon the leaking hole 27.

Referring to FIG. 2 through FIG. 4, the vibration system 3 comprises a voice coil 31 and a diaphragm 32 covered on the voice coil 31. The frame 1 further comprises a washer 5, an edge of the diaphragm is sandwiched between the washer 5 and the upper cover 4.

In general, since the orthographic projection of the first segment of the bending portion projected toward the base portion falls within the range of the base portion, the bending portion forms an inwardly folded structure. After the metal sheet injected into the cover body, an area formed between the bending portion and the base portion is filled with plastic material. Thus, with such configuration, a pulling strength of the metal sheet can be greatly improved, so that the connection between the metal sheet and cover body is stronger, and the upper cover is not easy to be detached and a good reliability of the speaker can be ensured.

It is to be understood, however, that even though numerous characteristics and advantages of the present exemplary embodiment have been set forth in the foregoing description, together with details of the structures and functions of the embodiment, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A speaker, comprising:
a frame;
a vibration system accommodated in the frame,
a magnetic circuit system accommodated in the frame,
an upper cover covered upon the frame,
wherein, the upper cover comprises a cover body and a metal sheet embedded into the cover body;
the metal sheet comprises a base portion located at a center thereof and a bending portion extending from a periphery of the base portion toward the frame; and
the bending portion comprises a first segment and a second segment connected between the first segment and the base portion;
an orthographic projection of the first segment projected toward the base portion falls within a range of the base portion.

2. The speaker according to claim 1, wherein the first segment is substantially parallel to the base portion.

3. The speaker according to claim 1, wherein a through hole is defined in a center of the cover body and the metal sheet covers on the through hole.

4. The speaker according to claim 2, wherein a through hole is defined in a center of the cover body and the metal sheet covers on the through hole.

5. The speaker according to claim 1, wherein the upper cover further comprises a first damping net attached to the metal sheet, and the metal sheet has an opening, and the first damping sheet covers upon the opening.

6. The speaker according to claim 2, wherein the upper cover further comprises a first damping net attached to the metal sheet, and the metal sheet has an opening, and the first damping sheet covers upon the opening.

7. The speaker according to claim 1, wherein the magnetic circuit system comprises a yoke, a main magnet attached to the yoke, a magnet conductive plate attached to the main magnet, an auxiliary magnet positioned at both sides of the main magnet, and an upper plate positioned above the auxiliary magnet, a magnet gap is formed between the main magnet and the auxiliary magnet, a leaking hole is defined in the yoke and corresponds to the magnet gap; and a second damping net covers on the leaking hole.

8. The speaker according to claim 2, wherein the magnetic circuit system comprises a yoke, a main magnet attached to the yoke, a magnet conductive plate attached to the main magnet, an auxiliary magnet positioned at both sides of the main magnet, and an upper plate positioned above the auxiliary magnet, a magnet gap is formed between the main magnet and the auxiliary magnet, a leaking hole is defined in the yoke and corresponds to the magnet gap; and a second damping net covers on the leaking hole.

9. The speaker according to claim 1, wherein the vibration system comprises a diaphragm, the frame further comprises a washer, an edge of the diaphragm is sandwiched between the washer and the upper cover.

10. The speaker according to claim 2, wherein the vibration system comprises a diaphragm, the frame further comprises a washer, an edge of the diaphragm is sandwiched between the washer and the upper cover.
